(19) United States
(12) Patent Application Publication
(10) Pub. No.: US 2025/0292089 A1
(43) Pub. Date: Sep. 18, 2025

(54) COMPUTING SYSTEM, NEURAL NETWORK TRAINING AND COMPRESSION METHOD, AND NEURAL NETWORK COMPUTATIONAL ACCELERATOR

(71) Applicant: POSTECH RESEARCH AND BUSINESS DEVELOPMENT FOUNDATION, Pohang-si (KR)

(72) Inventors: Seokhyeong KANG, Pohang-si (KR); Haena SONG, Pohang-si (KR); Jongho YOON, Pohang-si (KR); Dohun KIM, Pohang-si (KR); Taehyun OH, Pohang-si (KR); Eunji KWON, Pohang-si (KR)

(73) Assignee: POSTECH RESEARCH AND BUSINESS DEVELOPMENT FOUNDATION, Pohang-si (KR)

(21) Appl. No.: 18/925,872

(22) Filed: Oct. 24, 2024

(30) Foreign Application Priority Data
Mar. 14, 2024 (KR) 10-2024-0036087

(51) Int. Cl. G06N 3/082

(52) U.S. Cl. CPC G06N 3/082

(57) ABSTRACT

Disclosed is a computing system comprising a processor; and a neural network, wherein the processor obtains a third block circulant matrix, which is the Hadamard product of a first block circulant matrix and a second block circulant matrix from each layer of the neural network, trains the neural network by utilizing the third block circulant matrix as weights, and fine-tunes the first block circulant matrix and the second block circulant matrix by pruning a plurality of first sub-block circulant matrices included in the learned first block circulant matrix and a plurality of second sub-block circulant matrices included in the learned second block circulant matrix, respectively, for an arbitrary layer among layers of the neural network.

### CROSS-REFERENCE TO RELATED APPLICATIONS

This application claims priority to Korean Patent Application No. 10-2024-0036087, filed on Mar. 14, 2024, with the Korean Intellectual Property Office (KIPO), the entire contents of which are hereby incorporated by reference.

### BACKGROUND

### 1. Technical Field

The present disclosure relates to a computing system, a neural network training and compression method, and a neural network operation accelerator, and more particularly, to a technology capable of maintaining the output accuracy of the neural network while enhancing the rank of a block circulant matrix and increasing the pruning ratio.

### 2. Related Art

Deep neural networks (DNNs) have shown significant performance improvements as the size of the network increases, stacking layers deeper to extract complex features. However, the massive parameter size and computational overhead make it difficult to deploy DNNs on edge devices that must operate with limited resources and low power consumption. As a result, various methods have been proposed to compress and accelerate DNNs. One of the earliest methods introduced is unstructured pruning. Unstructured pruning measures the importance of individual weights and removes the less important ones. While it has the advantage of a high compression rate, the resulting network has irregular sparsity, making hardware acceleration difficult.

To address the issue of irregular computational patterns, network compression methods that enforce regular structures have been introduced. One such method is Block-Circulant Matrix (BCM) compression, where the weight tensor is divided into sub-blocks, and each block is represented as a circulant matrix. A circulant matrix has the same elements in all row vectors, but the elements of each row vector are rotated. Therefore, a single row vector can represent the entire weight tensor for each BCM, reducing memory complexity from O(n²) to O(n). Thanks to the regular computational pattern of sub-circulant matrices, BCM compression maintains high parallelism in computation. Additionally, matrix multiplication in circulant matrices can be replaced by “FFT-Elementwise MAC (eMAC)-IFFT,” reducing computational complexity from O(n²) to O(n log n).

Despite these advantages, BCM compression has significant limitations that degrade performance. First, when training weights to conform to the BCM structure, most weights must be identical to those in the first row, limiting representativeness. This constraint can restrict the expressiveness of the network, leading to significant accuracy degradation. Second, the trade-off between compression rate and accuracy loss is not flexible, and the size of BCM must be 2ⁿ for FFT computation. With larger BCM sizes, the compression process does not take into account the importance of weights, leading to a significant drop in accuracy. Therefore, it is necessary to overcome these limitations without compromising the advantages of BCM compression.

### SUMMARY

It is an object of the present disclosure to provide a rank-enhanced and highly-pruned block-circulant matrix (RP-BCM) framework, i.e., a neural network training and compression method and a computing system therefor.

It is another object of the present disclosure to provide a neural network operation accelerator, a dedicated hardware accelerator for RP-BCM.

It is another object of the present disclosure to provide a specialized dataflow method for BCM-compressed networks on resource-constrained field-programmable gate arrays (FPGAs).

It is still another object of the present disclosure to provide a dedicated skip mechanism capable of facilitating parallel computation by exploiting BCM-wise sparsity.

According to a first exemplary embodiment of the present disclosure, a computing system may comprise: a processor; and a neural network, and the processor may obtain a third block circulant matrix, which is the Hadamard product of a first block circulant matrix and a second block circulant matrix from each layer of the neural network, train the neural network by utilizing the third block circulant matrix as weights, and fine-tune the first block circulant matrix and the second block circulant matrix by pruning a plurality of first sub-block circulant matrices included in the learned first block circulant matrix and a plurality of second sub-block circulant matrices included in the learned second block circulant matrix, respectively, for an arbitrary layer among layers of the neural network.

The processor, when pruning the first sub-block circulant matrices and the second sub-block circulant matrices, may calculate the norm values of third sub-block circulant matrices generated by the Hadamard product of the first sub-block circulant matrices and the corresponding second sub-block circulant matrices, sort the calculated norm values, and determine which matrices to prune from the first sub-block circulant matrices and the second sub-block circulant matrices based on a predetermined pruning ratio.

The processor may determine the sub-block circulant matrices to be pruned as those with the smallest norm values among the sorted norm values, starting from the smallest, up to a quantity equal to the product of the predetermined pruning ratio and the number of first sub-block circulant matrices.

While the output accuracy of the neural network using the fine-tuned first block circulant matrix and the fine-tuned second block circulant matrix is equal to or greater than a predetermined accuracy, the process of fine-tuning by pruning the first block circulant matrix and the second block circulant matrix is repeated.

The predetermined pruning ratio may be updated by adding a predetermined step pruning ratio each time the first block circulant matrix and the second block circulant matrix are fine-tuned.

The processor, upon completion of pruning, may perform a Fast Fourier Transform on a pruned third block circulant matrix, which is the Hadamard product of a pruned first block circulant matrix and a pruned second block circulant matrix, provide the transformed values as inputs to accelerators for the operations of each layer, and provide index values regarding whether pruning has occurred to the accelerator to ensure that operations are not executed for the pruned sub-block circulant matrices among the sub-block circulant matrices of the pruned third block circulant matrix, the accelerators performing operations between the transformed values and the input data of the neural network only for the non-pruned sub-block circulant matrices excluding the pruned sub-block circulant matrices among the sub-block circulant matrices of the pruned third block circulant matrix using the index values.

According to a second exemplary embodiment of the present disclosure, a neural network training and compression method may comprise: obtaining a third block circulant matrix, which is the Hadamard product of a first block circulant matrix and a second block circulant matrix from each layer of the neural network; training the neural network by utilizing the third block circulant matrix as weights; and fine-tuning the first block circulant matrix and the second block circulant matrix by pruning a plurality of first sub-block circulant matrices included in the learned first block circulant matrix and a plurality of second sub-block circulant matrices included in the learned second block circulant matrix, respectively, for an arbitrary layer among layers of the neural network.

The fine-tuning may comprise: calculating the norm values of third sub-block circulant matrices generated by the Hadamard product of the first sub-block circulant matrices and the corresponding second sub-block circulant matrices; sorting the calculated norm values; and determining the first sub-block circulant matrices and the second sub-block circulant matrices corresponding to a determined number of small norm values as matrices to be pruned using a predetermined pruning ratio.

The determining the first sub-block circulant matrices and the second sub-block circulant matrices as matrices to be pruned may comprise: determining the sub-block circulant matrices to be pruned as those with the smallest norm values among the sorted norm values, starting from the smallest, up to a quantity equal to the product of the predetermined pruning ratio and the number of first sub-block circulant matrices.

The fine-tuning may comprise: repeating fine-tuning by pruning the first block circulant matrix and the second block circulant matrix while the output accuracy of the neural network using the fine-tuned first block circulant matrix and the fine-tuned second block circulant matrix is equal to or greater than a predetermined accuracy.

The fine-tuning may further comprise: updating the predetermined pruning ratio by adding a predetermined step pruning ratio each time the first block circulant matrix and the second block circulant matrix are fine-tuned.

According to a third exemplary embodiment of the present disclosure, a neural network computation accelerator may comprise: a buffer configured to receive input data for each layer of a neural network, a pruned weight block circulant matrix, and index values indicating whether pruning has occurred; a fast Fourier transform (FFT) processing element bank configured to perform a fast Fourier transform on the input data; a Multiply-Accumulate (MAC) processing element bank configured to perform multiplication and accumulation operations between the fast Fourier transform data and a sub-block circulant matrix of the weight block circulant matrix; a nonlinear module; and a controller; wherein the controller utilizes the index values regarding whether pruning has occurred to skip the execution of the MAC processing element bank for the pruned sub-block circulant matrices, executes the MAC processing element bank for the non-pruned sub-block circulant matrices, controls the FFT processing element bank to perform an inverse fast Fourier transform on the execution result data from the MAC processing element bank, and passes the transformed data through the nonlinear module to output as the output data of the layer.

The neural network computation accelerator may further comprise a shift operator interposed between the FFT processing element bank and the nonlinear module and configured to divide the block size of the weight block circulant matrix.

The pruned weight block circulant matrix may be the fast Fourier transformed data.

The pruned weight block circulant matrix may be a third block circulant matrix obtained by performing the Hadamard product of a first block circulant matrix and a second block circulant matrix for each layer of the neural network, training the neural network using the third block circulant matrix as weights, and fine-tuning the first block circulant matrix and the second block circulant matrix by pruning a plurality of first sub-block circulant matrices included in the learned first block circulant matrix and a plurality of second sub-block circulant matrices included in the learned second block circulant matrix for an arbitrary layer among layers of the neural network, resulting in the third block circulant matrix obtained from the Hadamard product of the fine-tuned first block circulant matrix and the fine-tuned second block circulant matrix.

The present disclosure is advantageous in terms of providing a rank-enhanced and highly-pruned block-circulant matrix (RP-BCM) framework, i.e., a neural network training and compression method and a computing system therefor. In the first phase of the neural network training and compression method, the Hadamard product of BCM is applied to mitigate the degradation of neural network output accuracy from a rank perspective. Subsequently, in the second phase of the neural network training and compression method, the importance of the weights within the BCM unit is assessed, enabling further compression through BCM-wise pruning. This allows for an increase in the pruning ratio while preserving accuracy.

The present disclosure is advantageous in terms of providing a neural network operation accelerator, a dedicated hardware accelerator for RP-BCM. This method can be utilized in the inference accelerator without any overhead.

The present disclosure is advantageous in terms of providing a specialized dataflow method for BCM-compressed networks on resource-constrained FPGAs.

The present disclosure is advantageous in terms of providing a dedicated skip mechanism capable of facilitating parallel computation by exploiting BCM-wise sparsity.

### BRIEF DESCRIPTION OF DRAWINGS

FIG. 1 is a diagram illustrating the conventional computation sequence of a circulant matrix.

FIG. 2 is a diagram illustrating a convolutional layer compressed by a conventional BCM.

FIG. 3 illustrates singular value reduction graphs for different conventional weight types.

FIG. 4 is a diagram illustrating the compression framework of the RP-BCM according to an embodiment of the present disclosure.

FIG. 5 is a diagram illustrating the reparameterization of BCM and the implementation of hadaBCM according to an embodiment of the present disclosure.

FIG. 6 illustrates the norm distribution graphs of a network trained according to an embodiment of the present disclosure.

FIG. 7 illustrates the pseudocode for the overall process of BCM-wise pruning according to an embodiment of the present disclosure.

FIG. 8 is a diagram illustrating the configuration of a hardware accelerator according to an embodiment of the present disclosure.

FIG. 9 is a diagram illustrating the configuration of a pruned BCM PE bank according to an embodiment of the present disclosure.

FIG. 10 is a diagram illustrating the detailed flow using a tile-based process for the compressed BCM network according to an embodiment of the present disclosure.

FIG. 11 is a diagram illustrating the tile-based data flow according to an embodiment of the present disclosure.

FIG. 12 is a diagram illustrating a computing system according to an embodiment of the present disclosure.

FIG. 13 is a flowchart illustrating the training method of a neural network according to an embodiment of the present disclosure.

FIG. 14 illustrates a graph showing the reduction in singular values for convolution, BCM, and hadaBCM according to one embodiment of the present disclosure.

FIG. 15 illustrates graphs showing the accuracy and parameter reduction of RP-BCM according to an embodiment of the present disclosure.

FIG. 16 illustrates the estimated execution cycles based on the pruning ratio according to an embodiment of the present disclosure.

FIG. 17 is a conceptual diagram illustrating a generalized neural network operation accelerator or computer system capable of performing at least part of the processes of FIGS. 1 to 16.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

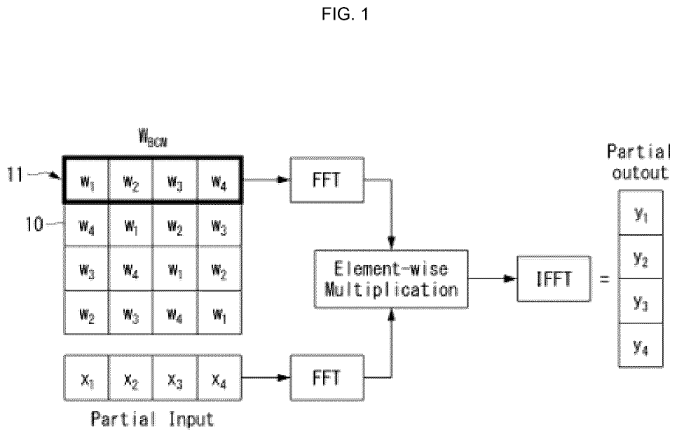

FIG. 1 is a diagram illustrating the conventional computation sequence of a circulant matrix.

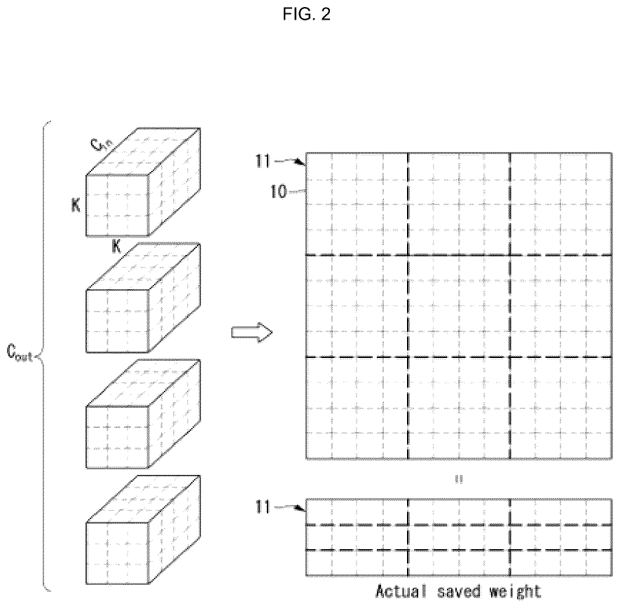

FIG. 2 is a diagram illustrating a convolutional layer compressed by a conventional BCM.

At least some of the configurations of the prior art shown in FIGS. 1 and 2 may be included as part of the present disclosure.

Hereinafter, descriptions will be made with reference to the accompanying drawings.

Block-circulant matrix (BCM) compression divides the weight tensor (W_{BCM}) into sub-blocks (e.g., each row) and represents each block in the form of a circulant matrix. The circulant matrix has the same elements in all row vectors (e.g., w₁, w₂, w₃, w₄), but the elements of each row vector are rotated. For example, the first row may have the order {w₁, w₂, w₃, w₄}, while the second row could have the order {w₄, w₁, w₂, w₃}.

As shown in FIG. 1, the matrix multiplication of the circulant matrix and the “FFT-eMAC (Element-wise Multiplication)—IFFT” with respect to the first row vector of the circulant matrix yield the same result. This reduces computational complexity from O(n²) to O(n log n). Additionally, memory storage complexity decreases from O(n²) to O(n), requiring only one row vector of the circulant matrix. After BCM compression, the regular structure of BCM allows for high parallelism in hardware, making it more efficient for network acceleration compared to other compression methods. Due to these advantages, BCM compression is widely used in various networks.

BCM-compressed convolution layers can be briefly described as follows.

The weight tensor of the convolution layer is denoted as W∈ [symbol] ^{K×K×C}^{ᵢₙ}^{×C}^{ₒᵤₜ}, where K, Cᵢₙ, and Cₒᵤₜ represent the weight kernel size, input channel size, and output channel size, respectively. In BCM compression, W forms multiple BCMs in both the input and output channel directions. That is, W is partitioned into a set of BCMs

$$\{ {W}_{bcm}^{0 , 0 , 0 , 0} , {W}_{bcm}^{0 , 0 , 0 , 1} , … , {W}_{bcm}^{kh , kw , \frac{{c}_{in}}{BS} , \frac{{c}_{out}}{BS}} , {W}_{bcm}^{K - 1 , K - 1 , \frac{{c}_{in} - 1}{BS} , \frac{{c}_{out} - 1}{BS}}$$

∈ [symbol] ^{BS×BS}, where BS denotes the size of each BCM.

For example, FIG. 2 shows BCM-compressed convolution weights with K=3, Cᵢₙ=Cₒᵤₜ=4 and BS=4. The elements of the 4×4 submatrices, delineated by bold dashed lines, may form each BCM. That is, W_{bcm} may contain 9 submatrices (W_{bcm}^{0,0,0,0}, W_{bcm}^{0,1,0,0}, W_{bcm}^{0,2,0,0} . . . , W_{bcm}^{2,2,0,0}). For example, ‘FFT-eMAC’ operation is performed between each BCM and a partial input vector. Then, the fully accumulated complex-valued output is restored to a real-valued output through IFFT. To aid understanding, the BCM compression process is denoted as a complete BCM, but in practice, only the first row vector of each W_{bcm} is used during the training (learning) and inference phases. For example, in W_{bcm}, only the first row vector 11 of the first row/first column sub-matrix 10 (W_{bcm}^{0,0,0,0}) is used. This is because the substituted calculation applies to both forward and backward propagation, as shown in FIG. 1.

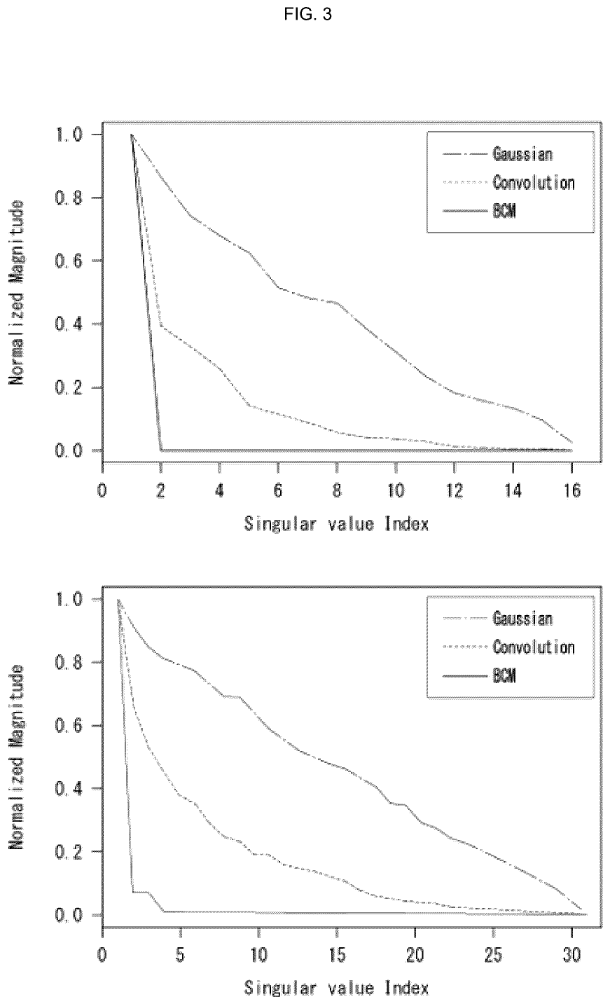

FIG. 3 illustrates singular value reduction graphs for different conventional weight types.

For example, FIG. 3 shows graphs visualizing the singular value reduction in the convolutional layers of the VGG-16 network trained on CIFAR-10, the upper and lower graphs representing the singular values of 16×16 and 32×32 matrices, respectively.

The horizontal axis of the graphs represents the singular value index, and the vertical axis represents the normalized magnitude.

According to general BCM compression, there are issues regarding limited representation from a rank perspective, constraints on compression parameters, and the need for specialized data flow for BCM-compressed networks on FPGAs.

Firstly, let's examine the issue of limited representation from a rank perspective. In neural networks, the matrix rank contains information about features. Therefore, the matrix rank measures a strict upper bound on the representational capacity of the weight matrix. However, due to the structural constraints of BCM, various BCM-compressed weights may ultimately have limited representational capacity. The effective rank constrained by the aforementioned limitations means that each layer of the network may lack sufficient feature representation capability, leading to a decline in performance.

FIG. 3 illustrates the aforementioned issues, where the rank condition of a matrix may be verified by observing the reduction of singular values. For example, the singular values of matrices that are close to full rank, such as Gaussian random matrices, decrease linearly. In contrast, matrices with poor rank conditions, such as convolutions, exhibit an exponential decrease. The singular values of BCM decrease extremely exponentially compared to the singular values of both Gaussian matrices and the original convolution. This suggests that the rank conditions of each BCM are unfavorable for sufficient feature extraction. In such situations, when the singular values that are less than 5% of the largest value account for over 50%, this may be considered a simple special case of effective rank measurement, defining BCM as having poor rank conditions.

In the VGG-16 network trained on CIFAR-10, over 70% of the BCMs across all layers exhibit poor rank conditions for sizes of 8, 16, and 32. This rate is notable compared to only 2% of the original convolution matrices having poor rank conditions. These observations suggest that the limited representational capacity of traditional BCM compression needs to be addressed.

Secondly, let's examine the issue of constraints on compression parameters. BCM compression relies solely on the block size (BS) to determine the compression ratio. Therefore, there are several limitations associated with this approach. First, increasing the BS directly impacts hardware costs. Typically, for FFT computation, BS must be 2ⁿ. Thus, achieving a higher compression ratio requires additional computational overhead. Second, the compression ratio cannot be determined at a fine-grained level. Simply adopting a larger 2ⁿ value for BS may result in significant accuracy degradation because BCM compression does not consider the importance of the weights. Consequently, there are very few practical options for compression parameters that yield a good trade-off between accuracy and compression ratio. For instance, in the REQ-YOLO study, only four values of BS (4, 8, 16, 32) were used to apply BCM compression to a CNN-based YOLO network. Similarly, the FTRANS study applied BCM compression to a Transformer-based network using only three values of BS (4, 8, 16). Assigning flexible compression ratios based on the importance of weights in BCM compression would enable a broader range of compression ratios.

Thirdly, let's examine the necessity for a specialized dataflow for BCM-compressed networks on FPGAs. The dataflow of CNN accelerators may be categorized into four types based on buffer size. The first type involves complete buffering of both inputs and weights, the second type has only weights fully buffered, the third type features only fully buffered inputs, and the final type has neither inputs nor weights fully buffered. The REQ-YOLO study proposes an FPGA-based accelerator for BCM-compressed networks, adopting the second type of dataflow and handling computation latency with “FFT-eMAC-IFFT.” However, resource-constrained FPGAs cannot buffer all weight data. Consequently, most CNN accelerators for edge devices utilize the last type of dataflow. In this dataflow, off-chip access is performed per tile, making it crucial to reuse data within limited buffers. Additionally, the input data directly relates to the amount of FFT computation in BCM-compressed networks, necessitating maximized reuse of input data to reduce redundant FFT calculations. Furthermore, since each computation has different data dependencies, processing “FFT-eMAC-IFFT” as a single computation delay in a tile-by-tile dataflow is inefficient. Therefore, simply adopting existing CNN dataflows is inefficient, and a specialized dataflow is necessary for BCM-compressed networks targeting resource-constrained FPGAs.

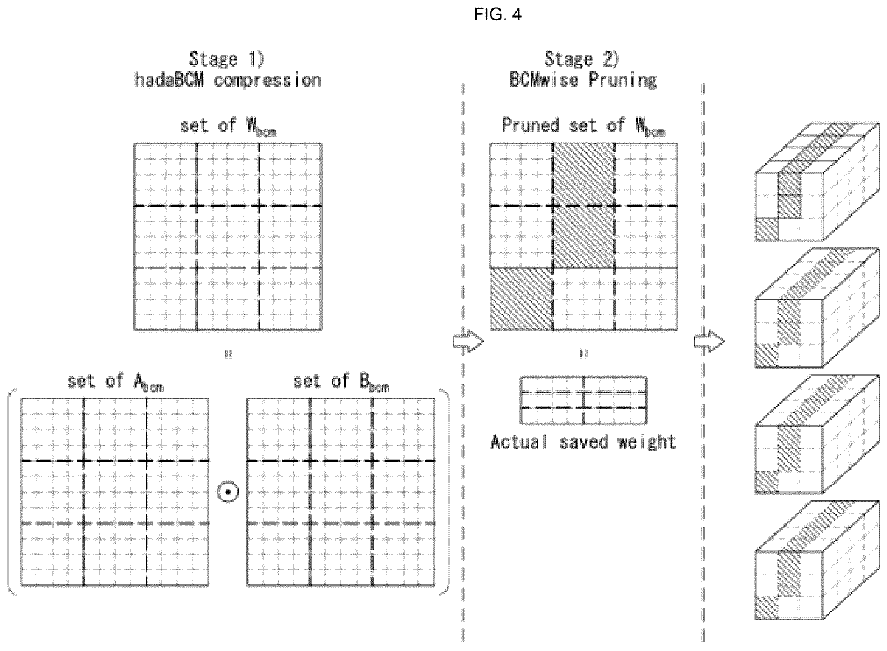

FIG. 4 is a diagram illustrating the compression framework of the RP-BCM according to an embodiment of the present disclosure.

As described above, many BCMs have limited representation from the perspective of rank. To achieve better rank conditions for these BCMs, the present disclosure provides, as shown in stage 1 of FIG. 4, a training phase incorporating Hadamard-BCM (hadaBCM) and offers a new parameterization of BCM that integrates the Hadamard product. Additionally, in stage 2 of FIG. 4 (BCM-wise pruning), weights of BCM units with low importance may be eliminated.

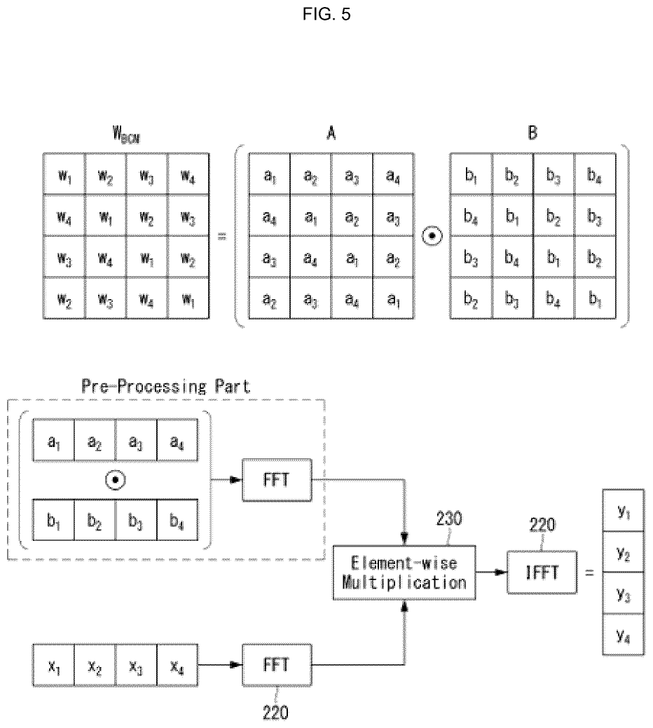

FIG. 5 is a diagram illustrating a diagram illustrating the reparameterization of BCM and the implementation of hadaBCM according to an embodiment of the present disclosure.

The present disclosure provides a method to enhance the rank, a measure of a matrix's representational capacity, by utilizing the Hadamard product compared to conventional BCM. According to this invention, the learning efficiency and model performance can be improved compared to using conventional BCM alone.

As shown in the upper diagram, hadaBCM replaces each W_{bcm} with the Hadamard product of two circulant matrices of the same size, represented as W_{bcm}=A_{bcm}⊙B_{bcm}. For circulant matrices A_{bcm} and B_{bcm}, the result of A_{bcm}⊙B_{bcm} is also a circulant matrix. Here, when rank(A_{bcm})=rₐ and rank(B_{bcm})=r_{b}, rank(W_{bcm})=rank(A_{bcm}⊙B_{bcm})≤rₐ*r_{b}, and the upper bound is maximized when rₐ=r_{b}. The weight update rule of hadaBCM has an intrinsic regularization effect that makes rₐ=r_{b}. Therefore, this condition may be satisfied without requiring any special training techniques other than applying the Hadamard product. The gradients of A_{bcm} and B_{bcm} with respect to the loss function (L) may be expressed as shown in Equation 1 below.

$$\frac{\partial ℒ}{\partial {A}_{bcm}} = \frac{\partial ℒ}{\partial {W}_{bcm}} ⊙ {B}_{bcm} , \frac{\partial ℒ}{\partial {B}_{bcm}} = \frac{\partial ℒ}{\partial {W}_{bcm}} ⊙ {A}_{bcm} \qquad [ Equation 1 ]$$

In the present disclosure, since the weights W_{bcm} are reparameterized through the Hadamard product of A_{bcm} and B_{bcm}, the differentiation during weight updates should target A_{bcm} and B_{bcm}, rather than W_{bcm}. Therefore, to update the matrix A_{bcm}, the partial derivative with respect to A_{bcm} should be taken for the loss function, and similarly, to update the matrix B_{bcm}, the partial derivative with respect to B_{bcm} should be taken for the loss function. Equation 1 represents the aforementioned process. Since the Hadamard product of A_{bcm} and B_{bcm} involves the element-wise scalar multiplication of matrix elements, the derivative of each element is similar to that of a first-order function, where the multiplied value remains the same. Thus, on the left side of Equation 1, the derivative with respect to A_{bcm} may be expressed as the product of the B_{bcm} and the derivative of W_{bcm}.

The gradients for A_{bcm} and B_{bcm} regulate each other, forming a feedback loop in opposite directions between A_{bcm} and B_{bcm}. This feedback effect stabilizes the values of A_{bcm} and B_{bcm} to achieve rₐ=r_{b} through repeated training epochs. By exploiting this property, the reparameterized W_{bcm} may improve the rank condition compared to the original BCM, thereby enhancing the accuracy and performance.

As described above, using two matrices instead of one can enrich the representational capacity of the weights. Additionally, since the rank of the matrix W_{bcm}, generated by the Hadamard product of the two matrices A_{bcm} and B_{bcm}, is higher than the rank of each individual matrix, the rank can be enhanced.

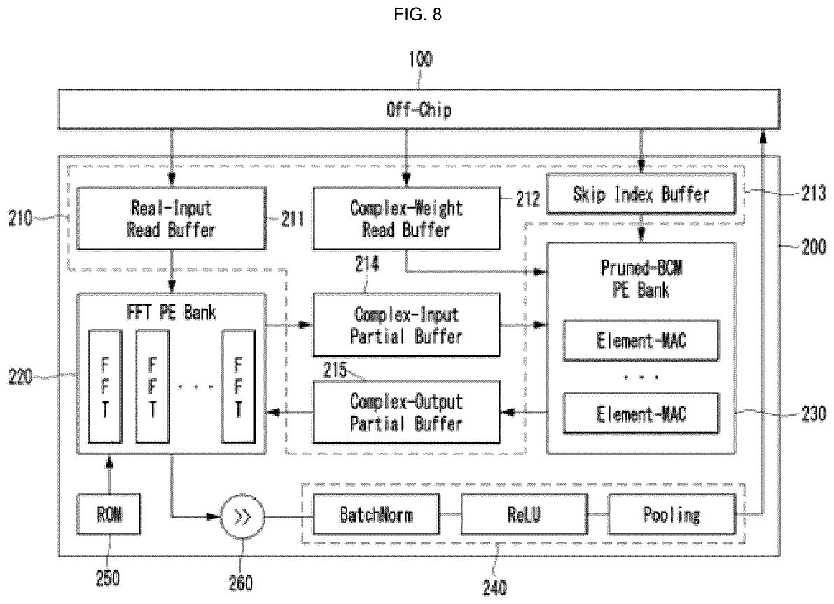

As shown in the lower diagram of FIG. 5, the Hadamard product and FFT computations may be pre-processed in the frequency domain before the inference stage (Pre-Processing Part). That is, hadaBCM does not require additional computational or storage overhead in the inference accelerator for BCM-compressed networks. Therefore, hadaBCM can improve accuracy while maintaining the advantages of previous BCM compression methods. The values of the Hadamard product and FFT calculations are stored off-chip (i.e., in the computing system 100 of FIG. 8), reducing both computational load and storage space.

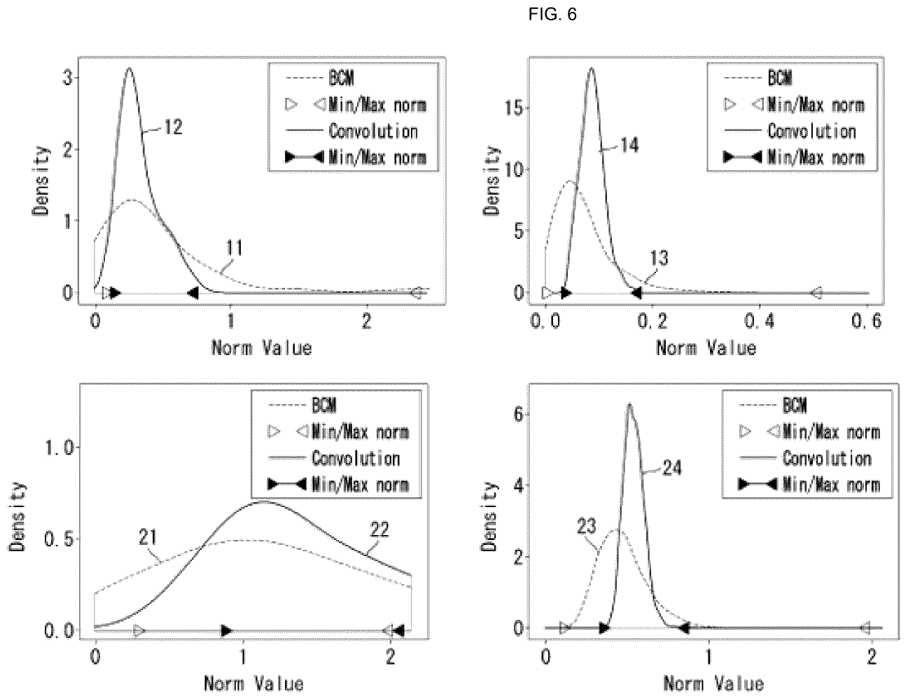

FIG. 6 illustrates the norm distribution graphs of a network trained according to an embodiment of the present disclosure.

The graphs 11, 13, 21, and 23 represent BCM, and the graphs 12, 14, 22, and 24 represent convolution.

Graphs 11 and 12 and graphs 13 and 14 show the norm distribution of pruning units in the first and last layers, respectively, of ResNet-18 on the CIFAR-10 dataset.

Similarly, graphs 21 and 22 and graphs 23 and 24 show the norm distribution of pruning units in the first and last layers, respectively, of ResNet-50 on the ImageNet dataset.

In the graphs, the horizontal axis represents the norm value, and the vertical axis represents the density.

The curves represent the estimated kernel density (KDE) of the norm distribution, while the triangle markers indicate the minimum and maximum norm values. In each graph, the black triangles represent the minimum/maximum norm values for the convolution layers, and the white triangles indicate the minimum/maximum norm values for the BCM layers.

As depicted in the second stage of FIG. 4, BCM-wise pruning can be used to eliminate the weights of low-importance BCM units. In this invention, the l2-norm may serve as a criterion for determining importance. Norm-based pruning is a type of filter pruning method. Such filter pruning methods typically have two requirements. The first requirement is that the deviation of the norms should be large, while the second is that the smallest norm should be small. The second requirement ensures that pruning has a minimal impact on the model's performance or results, as the pruned units have negligible norms.

However, traditional CNNs often struggle to meet both of these requirements, which has limited the effectiveness of norm-based criteria in CNNs.

This invention asserts that norm-based criteria are well-suited for BCM-wise pruning. This is because the structural properties of circulant matrices enable BCM-compressed networks to satisfy both aforementioned requirements. For a pruning unit (u∈ [symbol] ^{BS×BS}), a typical CNN's U_{cnn} has BS² individual values. In contrast, the U_{bcm} of the BCM-compressed network has BS values. As the sample size increases, the standard deviation of the sampling distribution decreases. Since smaller values contribute to the norm, U_{bcm} achieves a statistically wider norm distribution compared to U_{cnn}. In FIG. 6, the actual observations of the norm distribution for the trained network reveal that U_{bcm} exhibits a larger variance compared to U_{cnn} (refer to the triangular markers). Additionally, it can be observed that the minimum value of U_{bcm} is closer to zero in most layers (refer to the triangular markers). This satisfaction demonstrates the suitability of norm-based criteria for BCM-wise pruning.

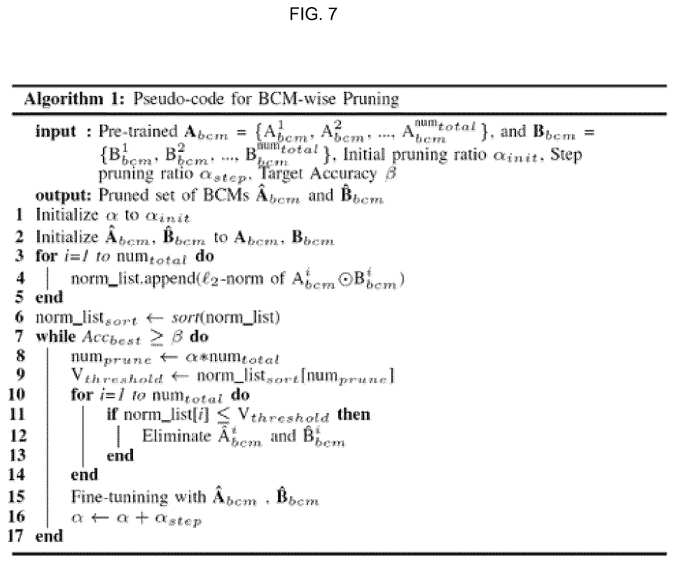

FIG. 7 illustrates the pseudocode for the overall process of BCM-wise pruning according to an embodiment of the present disclosure.

The pseudocode can be referred to as an algorithm for pruning.

As mentioned above, one of the drawbacks of conventional BCMs is that the size of the matrices is fixed as square, making it difficult for users to prune at desired ratios. As the BCM grows larger, the granularity of selectable pruning ratios increases, but this invention provides a method to prune at the BCM unit level, enabling finer-grained control over pruning ratios. That is, by pruning in block units of the matrix, this invention allows users to choose more suitable and flexible pruning ratios while maximizing the model's predictive performance. The pruning process according to the present disclosure is as follows.

First, after training the neural network with the aforementioned hadaBCM, the sets of BCMs, A_{bcm} and B_{bcm}, can be obtained. For example, referring to FIG. 4, the set A_{bcm} may be {A_{bcm}¹, A_{bcm}, . . . , A_{bcm}^{num}^{ₜₒₜₐₗ}}(e.g., numₜₒₜₐₗ=9). For example, the set B_{bcm} may also be {B_{bcm}¹, B_{bcm}², . . . , B_{bcm}^{num}^{ₜₒₜₐₗ}}(e.g., numₜₒₜₐₗ=9). That is, in this invention, pruning can be performed not at the block level (set) but at the sub-block level within the set. For example, the resulting set of A_{bcm} after pruning may be {A_{bcm}¹,A_{bcm}³,A_{bcm}⁴,A_{bcm}⁶,A_{bcm}⁸,A_{bcm}⁹}, the set of B_{bcm} may be {B_{bcm}¹,B_{bcm}³,B_{bcm}⁴,B_{bcm}⁶,B_{bcm}⁸,B_{bcm}⁹}, and the Hadamard product W_{bcm} of A_{bcm} and B_{bcm} may be {W_{bcm}¹,W_{bcm}³,W_{bcm}⁴,W_{bcm}⁶,W_{bcm}⁸,W_{bcm}⁹}.

In this case, for pruning, along with the BCM sets A_{bcm} and B_{bcm}, an initial pruning ratio, a step pruning ratio, and a target accuracy are provided as inputs for the pruning process. The initial pruning ratio αᵢₙᵢₜ may be a predetermined parameter value. The step pruning ratio αₛₜₑₚ may be a parameter value added to the current pruning ratio to update the pruning ratio α after the fine-tuning of A_{bcm} and B_{bcm} is completed. The target accuracy β may be a predetermined parameter value representing the desired accuracy for the output data of the neural network.

The l2-norm of W_{bcm}ⁱ=A_{bcm}ⁱ⊙B_{bcm}ⁱ may be obtained. Here, i may be 1, . . . numₜₒₜₐₗ. The norm values are sorted in ascending order, and the number of BCMs to be removed, numₚᵣᵤₙₑ, may be determined based on the adaptive pruning ratio α. Therefore, A_{bcm}ⁱ and B_{bcm}ⁱ with norms lower than the V_{threshold} are removed, and the network can be fine-tuned. Since the model's performance slightly decreases each time A_{bcm}ⁱ and B_{bcm}ⁱ are removed, the fine-tuning process described above is the process of tuning the model's performance to be closer to that of the original model.

First, the pruning ratio α may be initialized with a predefined initial pruning ratio αᵢₙᵢₜ. As long as the fine-tuned accuracy meets the target accuracy β, the pruning ratio α may be incrementally increased by small steps (by adding the step pruning ratio αₛₜₑₚ), allowing for updates to larger ratios. The fine-tuned accuracy ACC_{best} is repeatedly fine-tuned using the pruned network with the updated pruning ratio α until it reaches the target accuracy β. By adjusting the pruning ratio α and the target accuracy β, the trade-off between accuracy and compression ratio may be determined more precisely. In this process, the accuracy ACC_{best} may also be fine-tuned alongside A_{bcm} and B_{bcm}.

FIG. 8 is a diagram illustrating the configuration of a hardware accelerator according to an embodiment of the present disclosure.

The hardware accelerator 200 may receive data from an off-chip (e.g., computing system) 100.

The hardware accelerator 200 may include a controller (not shown), a buffer 210, an FFT processing elements (PE) bank 220, a pruned-BCM PE bank 230, a non-linear module 240, ROM 250, and a shift operator 260.

The controller may control the buffer 210, the FFT PE bank 220, the pruned-BCM PE bank 230, the non-linear module 240, the ROM 250, and the shift operator 260.

The buffer 210 may include a real-input read buffer 211, a complex-weight read buffer 212, a skip index buffer 213, a complex-input partial buffer 214, and a complex-output partial buffer 215.

With reference to FIGS. 5 and 8, the real-input read buffer 211 may receive the values x₁, x₂, x₃, and x₄ as input data for the neural network.

The complex-weight read buffer 212 may directly load the pre-processed weight data obtained from the Hadamard product and FFT. The weights generated by the Hadamard product, which form the block circulant matrix, may be the result of the hadaBCM compression and BCM-wise pruning described in FIGS. 4, 5, and 7.

The skip index buffer 213 may load data indicating whether the sub-block circulant matrix has been pruned during the pruning process.

The complex-input partial buffer 214 may load the complex partial input data output from the FFT PE bank 220, and this complex partial input data may be passed to the pruned BCM PE bank 230.

The complex-output partial buffer 215 may load the complex partial output data output from the pruned BCM PE bank 230, and this complex partial output data may be passed to the FFT PE bank 220.

The FFT PE bank 220 may perform the conversion between real data and complex data. Essential data for the FFT, such as the twiddle factor, may be pre-stored in ROM 250.

The pruned BCM PE bank 230 may perform eMAC using BCM-wise pruning to generate complex partial output data.

The FFT PE bank 220 may process the complex partial output data through IFFT, and the processed data may be output from the hardware accelerator 200 via the shift operator 260 and the non-linear model 240, then provided to the off-chip 100.

The non-linear model 240 may include BatchNorm, ReLU, and Pooling.

The accelerator may be capable of processing the sparse matrix generated by the aforementioned pruning method. By using the accelerator according to the present disclosure, the computation speed and throughput during inference can be improved.

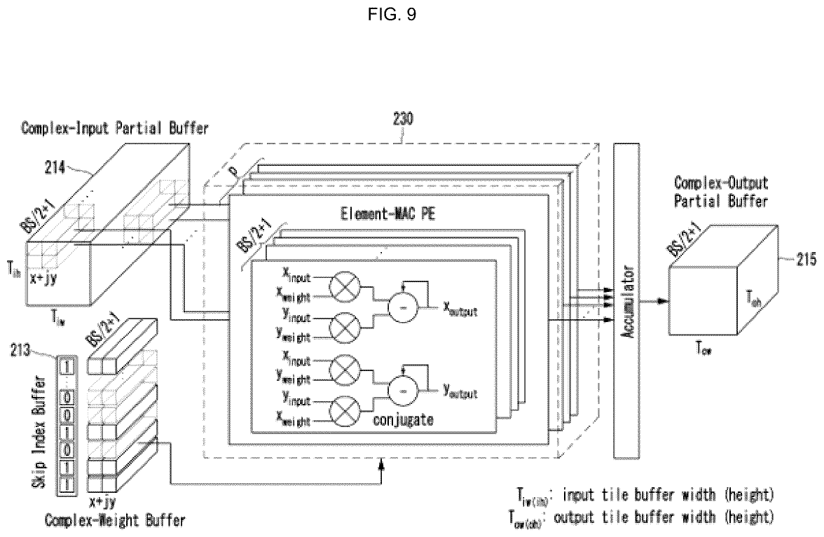

FIG. 9 is a diagram illustrating the configuration of a pruned BCM PE bank according to an embodiment of the present disclosure.

The design of the pruned BCM PE bank in FIG. 9 may enable pruning on a per BCM basis. That is, rather than using a single large BCM, this invention may provide a BCM PE bank that allows for the acceleration by pruning each smaller, distinct BCM. Referring to FIG. 4, acceleration may be improved through compression via pruning in stage 2. Additionally, for example, since the sub-matrix is a circulant matrix, the values may be stored in a compressed block form from a 4×4 BCM to a 4×1 after pruning for inference. Here, the matrix-vector multiplication may be performed using FFT on a 4×1 basis.

This will be explained with reference to both FIG. 8 and FIG. 9.

The FFT PE of the FFT PE bank 220 may be designed using the well-known Cooley-Tukey FFT algorithm. IFFT may be computed in the FFT PE bank 220 using a BS size-divider and conjugation. Since the FFT size is always 2ⁿ, the BS size-divider may be implemented using the log₂ BS shift operator 260 to reduce the cost of expensive hardware dividers. The conjugation may be integrated into the MAC of the pruned BCM PE bank 230.

The pruned BCM PE bank 230 may include multiple element-MAC (eMAC) PEs and a PE controller (not shown). The parallelism element p may be determined based on resource capabilities, indicating the number of pruned BCM PEs in a single bank.

A single eMAC PE may execute complex eMAC on BS-sized partial weights and BS-sized partial inputs. The calculation of BS size may include only BS/2+1 MAC operations since the FFT result is conjugate symmetric. For example, the two blocks (x+jy) corresponding to row 1/column 2 in the complex-weight read buffer 212 may relate to partial weights, and the two blocks (x+jy) corresponding to row 1/column 2 in the complex-input partial buffer 214 may relate to partial inputs. The p PEs may execute eMAC in parallel on different partial inputs while reusing the same BS weights.

The PE controller may appropriately allocate input data to each PE through skip indexing. For example, before computation, the PE controller may check the skip index bits indicating whether the corresponding BCM has been pruned. When the skip index bit is 0, the PE controller may skip executing the PE bank for the pruned weight. The PE controller may then immediately execute the PE bank for the next non-pruned BCM weight.

The data flow can maintain high parallelism as multiple PEs share common partial weights and perform skip processing, even in the presence of sparsity. The skip index buffer 213 may represent an overhead of one bit per BCM. For example, in the case of a convolution layer of size K×K×Cᵢₙ×Cₒᵤₜ, the size of the skip index buffer 213 is only K×K×(Cᵢₙ/BS)×(Cₒᵤₜ/BS)×1 bit. Overall, the computational process may be maintained with the cost of checking skip indices, which consumes very little time compared to the main computation of the PEs.

An accumulator may be placed between the pruned BCM PE bank 230 and the complex-output partial buffer 215.

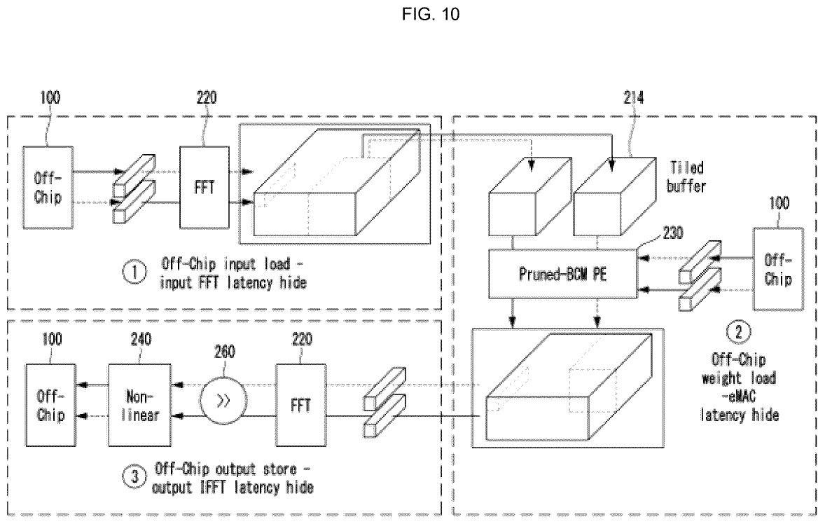

FIG. 10 is a diagram illustrating the detailed flow using a tile-based process for the compressed BCM network according to an embodiment of the present disclosure.

In FIG. 10, the solid and dotted arrows indicate separate double buffering.

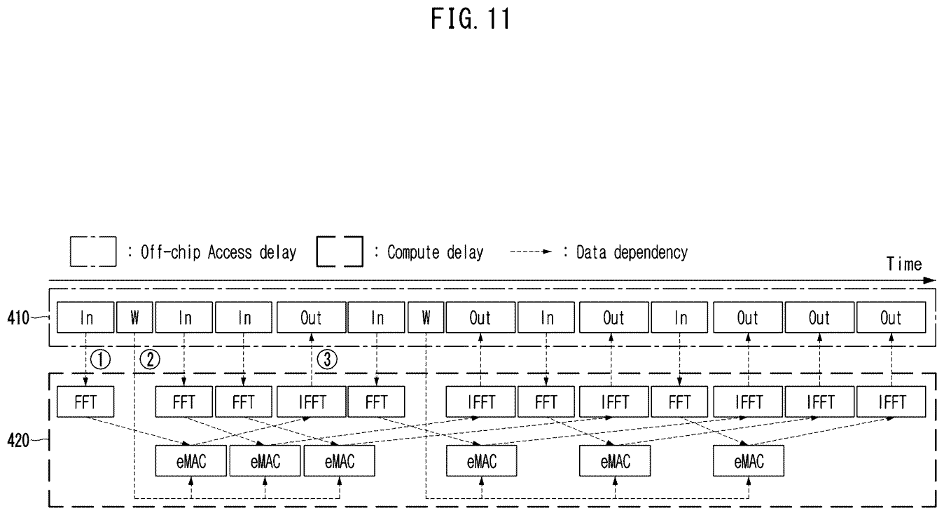

FIG. 11 is a diagram illustrating the tile-based data flow according to an embodiment of the present disclosure.

A single weight tile may be reused across multiple input tiles to generate several output tiles.

FIG. 11 shows off-chip access (IN, W, OUT) and computation (FFT, eMAC, IFFT) over time. Specifically, FIG. 11 shows the off-chip access delay 410, computation delay 420, and the direction of data dependency.

Hereinafter, descriptions will be made with reference to FIGS. 10 and 11.

Most accelerators for edge devices use a data flow where the input and weights are not fully buffered due to insufficient resources. Therefore, the present disclosure provides a fine-grained data flow using a tile-based process for the BCM-compressed network as shown in FIG. 9.

For each tile, there are three off-chip accesses: input read (In), weight read (W), and output storage (Out). A BCM-compressed network may consist of three types of computations: FFT (C_{fft}), eMAC (C_{emac}), and IFFT (C_{ifft}). These computations may be separated with their respective compute delays and double buffering may be applied to each off-chip access. Each computation C has a different data dependency that requires off-chip access. C_{fft}, C_{emac}, and C_{ifft} may require off-chip access for real inputs, complex weights, and real outputs, respectively. Each double buffering may hide the corresponding off-chip access latency along with the computation latency (C latency). The double buffering for C_{fft} and C_{ifft} requires only a small overhead for two BS-sized buffers. This is because FFT and IFFT are executed per BS size. In the case of C_{emac}, the overhead may vary depending on the parallelism of the PE bank 230. The size of the complex input/output buffers 214 and 215 and the parallelism of the PE bank 230 may be determined based on the resource capacity of the targeted FPGA. This may directly affect the compute delay of C_{emac}. Additionally, each PE may hide the latency between each computation C as well as the latency between off-chip access and computation.

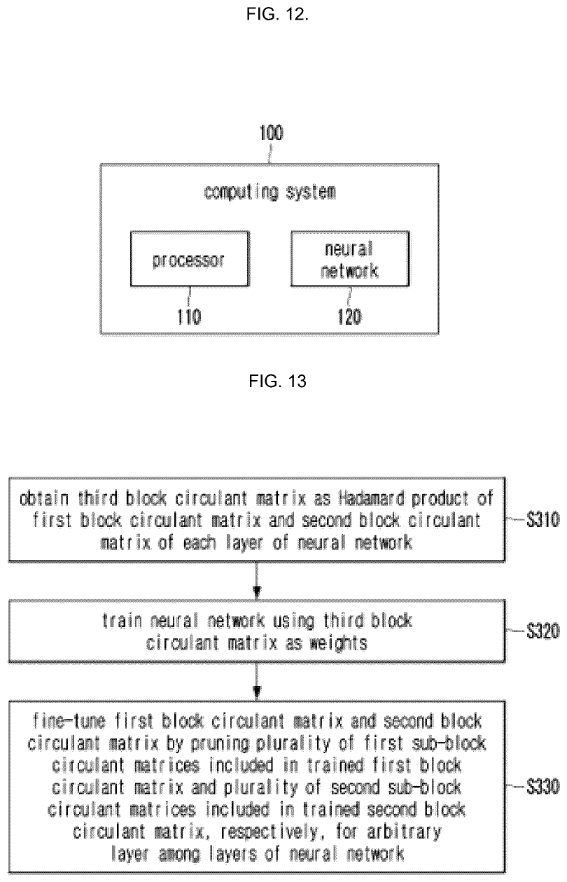

FIG. 12 is a diagram illustrating a computing system according to an embodiment of the present disclosure.

FIG. 13 is a flowchart illustrating the training method of a neural network according to an embodiment of the present disclosure.

Hereinafter, descriptions will be made with reference to FIGS. 12 and 13.

The computing system 100 may include a processor 110 and a neural network 120.

Each of the following operations may be executed by the processor 110 of the computing system 100.

In operation S310, the third block circulant matrix W_{bcm}, which is the Hadamard product of the first block circulant matrix A_{bcm} and the second block circulant matrix B_{bcm} of each layer of the neural network 120, may be obtained. That is, during the learning phase, the third block circulant matrix may first be obtained through the Hadamard product in each layer.

In operation S320, the neural network 120 may be trained using the third block circulant matrix W_{bcm} as weights. Here, the neural network 120 may be trained using a pre-prepared dataset, and once training is completed, the values of the first block circulant matrix and the second block circulant matrix may be determined. That is, the values of the first block circulant matrix and the second block circulant matrix may be updated each time the training is repeated, and the final values may be determined once training is complete.

In the learning process, as in operations S310 and S320, operation S310 is included; however, in the inference process, since the trained first block circulant matrix and the second block circulant matrix always have fixed values, the third block circulant matrix obtained through the Hadamard product of the first and second block circulant matrices can be directly applied without any changes. That is, in the inference process, operation S310 may be omitted.

In operation S330, by pruning plurality of first sub-block circulant matrices A_{bcm}¹, A_{bcm}², . . . , A_{bcm}^{num}^{ₜₒₜₐₗ} included in the trained first block circulant matrix and plurality of second sub-block circulant matrices B_{bcm}¹, B_{bcm}², . . . , B_{bcm}^{num}^{ₜₒₜₐₗ} included in the trained second block circulant matrix, respectively, for arbitrary layer among layers of the neural network 120, the first block circulant matrix and the second block circulant matrix can be fine-tuned.

Operation S330 may include operations S331 to S333.

In operation S331, the norm values of the third sub-block circulant matrices generated by the Hadamard product between each corresponding first sub-block circulant matrix and the second sub-block circulant matrices may be calculated. Although the first and second block circulant matrices are fine-tuned by the pruning process, the Hadamard product may only be used when calculating the norm values.

In operation S332, the calculated norm values may be sorted.

In operation S333, the first and second sub-block circulant matrices corresponding to a determined number of small norm values using a predetermined pruning ratio α, may be determined as matrices to be pruned. Operation S333 may involve determining the sub-block circulant matrices to be pruned as many as the value obtained by multiplying the predetermined pruning ratio α by the number of the first sub-block circulant matrices (numₜₒₜₐₗ) from the smallest value among the sorted norm values.

In this case, operation S330 may be repeated while the output accuracy ACC_{best} of the neural network using the fine-tuned first block circulant matrix and the fine-tuned second block circulant matrix is greater than or equal to a predetermined accuracy β.

Therefore, operation S330 may further include an operation of updating the predetermined pruning ratio α to a value obtained by adding the predetermined step pruning ratio (αstep) each time the first block circulant matrix and the second block circulant matrix are fine-tuned.

Additionally, the norm value calculation in operation S331 may be based on the fine-tuned first block circulant matrix and the fine-tuned second block circulant matrix.

Here, when the pruning is completed, the processor 110 may perform a fast Fourier transform on the third block circulant matrix, which is the Hadamard product of the completed first block circulant matrix and the completed second block circulant matrix. The processor 110 may also provide the transformed values as input to the accelerator for operations of each layer. Furthermore, the processor 110 may provide index values regarding whether pruning has occurred to the accelerator to ensure that operations are not executed for the pruned sub-block circulant matrices among the sub-block circulant matrices of the third block circulant matrix.

In this case, the accelerator may perform operations only between the transformed values and the input data of the neural network for the remaining sub-block circulant matrices, excluding the pruned sub-block circulant matrices, using the index values.

With reference to FIG. 8, the neural network operation accelerator may be configured as follows.

The accelerator 200 may include a buffer 210, an FFT processing element bank 220, a MAC processing element bank 230, a nonlinear module 240, and a controller.

The buffer 210 may receive input data from each layer of the neural network 120, the pruned weight block circulant matrix, and index values indicating whether pruning has been performed.

The FFT processing element bank 220 may perform a fast Fourier transform on the input data.

The MAC processing element bank 230 may execute multiplication-accumulation (MAC) operations between the fast Fourier transformed data and any sub-block circulant matrix of the weight block circulant matrix.

The controller may use the index values indicating whether or not pruning has been performed to skip the execution of the MAC processing element bank for the arbitrary sub-block circulant matrix when pruning has been performed on the sub-block circulant matrix, and to execute the MAC processing element bank when the sub-block circulant matrix has not been pruned.

The controller may control the FFT processing element bank to perform an inverse fast Fourier transform on the execution result data from the MAC processing element bank. The controller may then pass the transformed data through the nonlinear module to output it as the output data of the layer.

The neural network operation accelerator 200 may be arranged between the FFT processing element bank 220 and the nonlinear module 240 and may further include a shift operator 260 that divides the block size of the weight block circulant matrix.

In this case, the pruned weight block circulant matrix may represent the data transformed by the fast Fourier transform.

The pruned weight block circulant matrix may be obtained by acquiring a third block circulant matrix from the Hadamard product of the first block circulant matrix and the second block circulant matrix of each layer of the neural network, using the third block circulant matrix as a weight to pre-train the neural network, and fine-tuning the first and second block circulant matrices by pruning multiple first sub-block circulant matrices included in the learned first block circulant matrix and multiple second sub-block circulant matrices included in the learned second block circulant matrix for arbitrary layer among layers of the neural network, resulting in a third block circulant matrix obtained from the Hadamard product of the fine-tuned first and second block circulant matrices.

The aforementioned neural network training method enhances the trade-off between the accuracy of the neural network and pruning. Since RP-BCM addresses the issues of rank in BCM, it is possible to enhance the trade-off limit between accuracy and the lightweight nature of pruning.

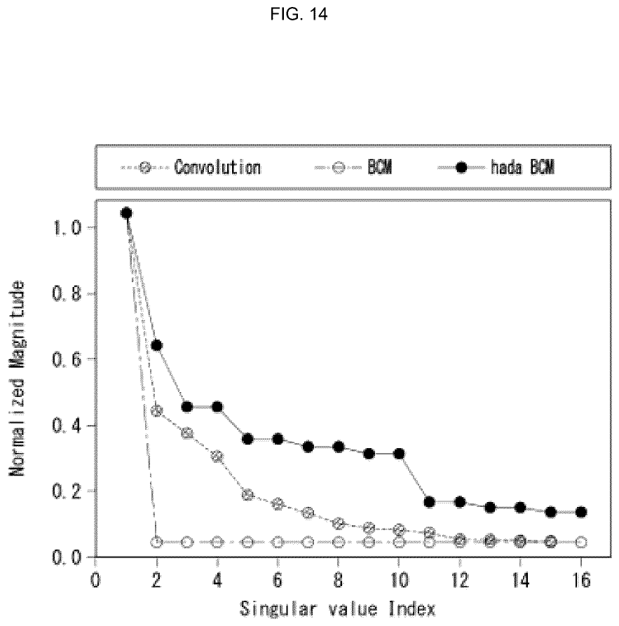

FIG. 14 illustrates a graph showing the reduction in singular values for convolution, BCM, and hadaBCM according to one embodiment of the present disclosure.

The horizontal axis of the graph represents the singular value index, and the vertical axis represents the normalized magnitude.

FIG. 14 demonstrates the same singular value reduction in BCM as shown in the upper graph of FIG. 3. Compared to BCM, the singular values of hadaBCM decrease more linearly. This more linear decrease in singular values indicates that the rank condition of the matrix has been improved. This improved BCM was observed across the entire network. In the case of traditional BCM-compressed VGG-16 for Cifar-10, 72.2% of BCMs had poor rank conditions. However, in hadaBCM-compressed networks, only 2.1% of BCMs exhibited poor rank conditions. This enhanced rank condition of BCMs leads to better representations, resulting in improved accuracy.

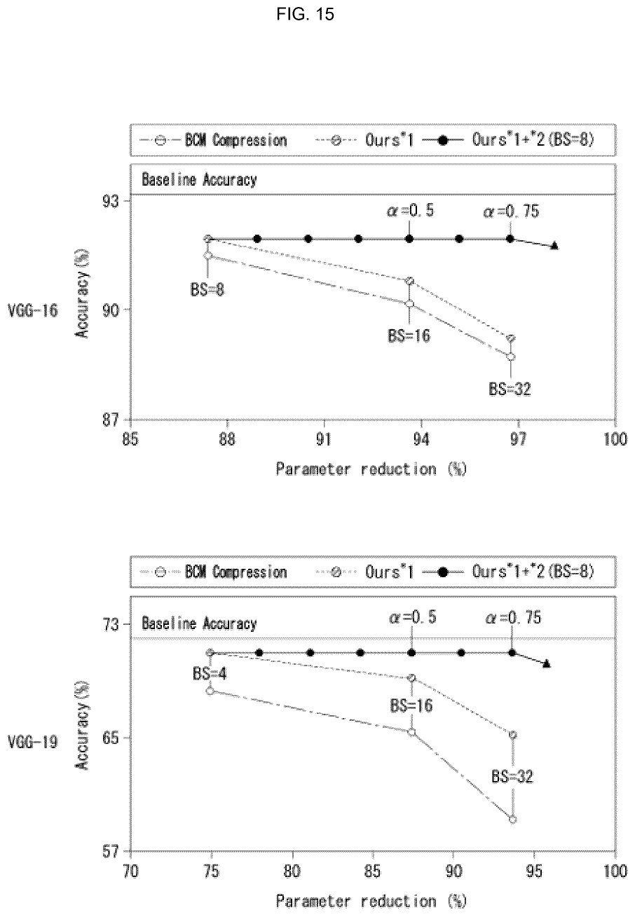

FIG. 15 illustrates graphs showing the accuracy and parameter reduction of RP-BCM according to an embodiment of the present disclosure.

The horizontal axis of the graphs represents parameter reduction (%), and the vertical axis represents accuracy (%).

The upper graphs show the results for the VGG-16 network trained on Cifar-10, respectively, when applying BCM compression (BCM Compression), applying only hadaBCM (Ours*1), and applying both hadaBCM and BCM-wise pruning (Ours*1+*2).

The lower graphs show the results for the VGG-19 network trained on Cifar-100, respectively, when applying BCM compression (BCM Compression), applying only hadaBCM (Ours*1), and when applying both hadaBCM and BCM-wise pruning (Ours*1+*2).

The upper and lower graphs show the results of fine-tuning the VGG-16 network on Cifar-10 and the VGG-19 network on Cifar-100 with predetermined accuracies p=92.0% and β=71.0%, respectively, using weights by the BCM-wise method after applying hadaBCM.

In the graph where both hadaBCM and BCM-wise pruning are applied, the triangular markers indicate the stopping points of the algorithm in FIG. 7 within the target accuracy β (92.0% and 71.0%, respectively).

For comparison, the upper and lower graphs show a that matches the same total parameter reduction as the traditional BCM compression. For example, when BS=8 and α=0.5 are set, the VGG-16 showed the same parameter reduction as the traditional BCM compression. When BS=8 and α=0.75 are set, the VGG-16 showed a 3.25% improvement in accuracy compared to the traditional BCM compression with the same parameter reduction. In the case of a more complex dataset (VGG-19 on Cifar-100), the results with BS=4 and α=0.75 showed an 11.57% improvement in accuracy compared to the traditional BCM compression using only BS=16. The impact of BCM-wise pruning may be divided into two main points. First, unlike traditional BCM compression, which only has a compression parameter (BS) that increases exponentially as 2ⁿ, the BCM-wise pruning method can provide a wider range of compression ratios by setting an additional adaptive parameter α. Additionally, it is possible to achieve a much larger parameter reduction and better accuracy performance by compressing the network considering the importance of weights.

The accuracy losses of the aforementioned VGG-16 and VGG-19 networks are 1.2% and 1.3%, respectively. With such small accuracy losses, the method of the present disclosure achieved parameter reductions of 96.75% and 93.68% in each network. Greater compression may be achieved by adjusting α and β in the algorithm of FIG. 7. Applying RP-BCM to more complex datasets, such as ResNet-50 on ImageNet, demonstrates the comparison of accuracy, FLOPs reduction, and parameter reduction. In the present disclosure, experiments were conducted using BS values of 8 and 4 while adjusting the target Top-1 accuracy β in two categories.

According to this invention, the degree of compression can be finely determined by adjusting the target accuracy β. Since parameter size directly affects DRAM access, which is the largest latency bottleneck, the present disclosure facilitates easier deployment of neural networks in embedded systems.

By performing high compression using the RP-BCM method of the present disclosure, the number of DRAM accesses can be reduced, and the model can be made lightweight. Reducing DRAM accesses allows for low-power execution of model inference, and model lightweighting enables operation even on relatively low-performance embedded systems, making neural network deployment easier.

Furthermore, the present disclosure provides RP-BCM-specific hardware, where complex operations are replaced with simpler ones like FFT, achieving lower power consumption compared to general computing systems.

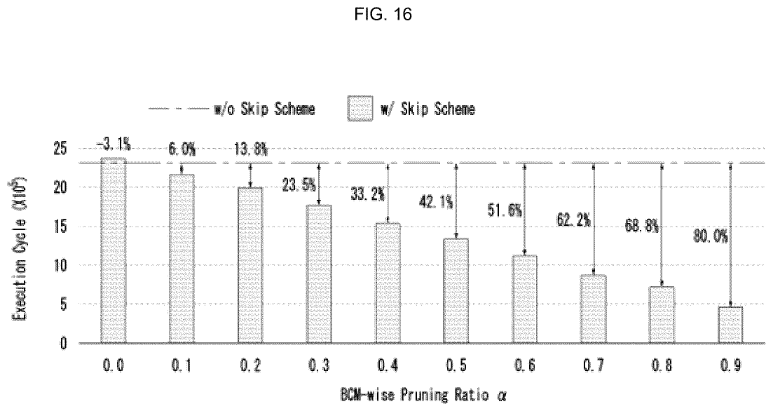

FIG. 16 illustrates the estimated execution cycles based on the pruning ratio according to an embodiment of the present disclosure.

The horizontal axis of the graph represents the BCM-wise pruning ratio (a), and the vertical axis represents the execution cycles (×10⁵).

The line graph represents the case without applying the skip method, and the bar graph represents the case with the skip method applied.

In this invention, one layer of ResNet-18 was simulated. The feature map size was 128×28×28, and the weight kernel size was 3×3. By applying BCM-wise sparsity, the proposed PE demonstrated a linear trend in cycle reduction based on a. This indicates that the design of the proposed accelerator can maintain high parallelism while retaining sparsity. To estimate the overhead time for the skip operation, the execution cycles of the proposed PE (the pruned-BCM PE Bank's PE in FIG. 8) were compared with those of a traditional PE when α=0. For a layer that had not undergone pruning (i.e., α=0), the execution cycles increased by 3.1% compared to the traditional PE. This is a very small overhead compared to the main computation. Consequently, the design of the proposed accelerator can maintain high parallelism with negligible additional overhead in both resource usage and execution time by exploiting BCM-wise sparsity.

According to the present disclosure, pruning results in an intermediate sparse matrix in the overall matrix, and when operations are performed without a logic to properly skip the pruned blocks, the number of cycles required for computation will be the same for both the pruned and non-pruned versions. Therefore, the ability to effectively skip the blocks that have been pruned is what distinguishes the aforementioned accelerator of the present disclosure. The above-described skipping process can be accomplished through the skip index buffer shown in FIG. 8.

Various network compression methods have been proposed to execute deep neural networks in resource-constrained embedded systems. Among these, block circulant matrix (BCM) compression is one of the promising hardware-friendly methods for acceleration and compression. However, BCM compression has several limitations, such as limited representation due to the structural characteristics of circulant matrices, restrictions on compression parameters, and the need for specialized data flow for accelerators performing BCM operations.

To overcome these limitations, the present disclosure provides a framework for rank-enhanced and highly pruned block circulant matrices (RP-BCM), which includes neural network training and compression methods, as well as computing systems for these purposes.

In the first phase of the neural network training and compression method, the Hadamard product of BCM is applied to mitigate the degradation of neural network output accuracy from a rank perspective. To overcome the lack of representation in traditional BCM compression from a rank perspective, Hadamard-BCM (hadaBCM) can be provided.

Subsequently, in the second phase of the neural network training and compression method, the importance of the weights within the BCM unit is assessed, allowing for more effective compression through BCM-wise pruning. This allows for an increase in the pruning ratio while preserving accuracy.

The present disclosure is advantageous in terms of providing a neural network operation accelerator, a dedicated hardware accelerator for RP-BCM. The method of hadaBCM can be utilized in the inference accelerator without any overhead.

The present disclosure is advantageous in terms of providing a specialized dataflow for BCM-compressed networks on resource-constrained FPGAs. Additionally, a processing element (PE) design can be provided to utilize BCM-wise sparsity. The present disclosure is advantageous in terms of providing a dedicated skip mechanism capable of facilitating parallel computation by exploiting BCM-wise sparsity.

The present disclosure focuses on the method of utilizing RP-BCM and dedicated hardware based on CNNs. In addition to CNNs, the invention can be applied to various neural networks that consist of matrix multiplication, such as fully connected (FC) layers, LSTM, GNN, transformers, and object detection in conventional CNN-based YOLO networks. That is, this invention enables matrix multiplication operations to be converted into BCM operations, facilitating broader applications across a variety of neural networks.

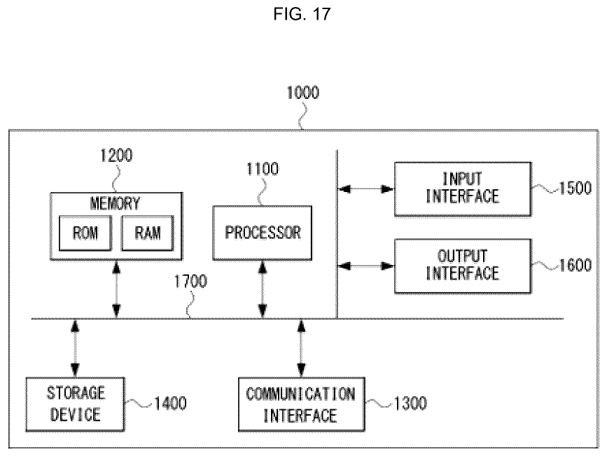

FIG. 17 is a conceptual diagram illustrating a generalized neural network operation accelerator or computer system capable of performing at least part of the processes of FIGS. 1 to 16.

At least part of the neural network training and compression method according to an embodiment of the present disclosure is executable by the computing system 1000 of FIG. 17.

With reference to FIG. 17, the computing system 1000 according to an embodiment of the present disclosure may include a processor 1100, a memory 1200, a communication interface 1300, a storage device 1400, an input interface 1500, an output interface 1600, and a bus 1700.

The computing system 1000 according to an embodiment of the present disclosure may include at least one processor 1100 and a memory 1200 storing instructions for instructing the at least one processor 1100 to perform at least one step. At least some steps of the method according to an embodiment of the present disclosure may be performed by the at least one processor 1100 loading and executing instructions from the memory 1200.

The processor 1100 may refer to a central processing unit (CPU), a graphics processing unit (GPU), or a dedicated processor on which the methods according to embodiments of the present disclosure are performed.

Each of the memory 1200 and the storage device 1400 may be configured as at least one of a volatile storage medium and a non-volatile storage medium. For example, the memory 1200 may be configured as at least one of read-only memory (ROM) and random access memory (RAM).

Also, the computing system 1000 may include a communication interface 1300 for performing communication through a wireless network.

In addition, the computing system 1000 may further include a storage device 1400, an input interface 1500, an output interface 1600, and the like.

In addition, the components included in the computing system 1000 may each be connected to a bus 1700 to communicate with each other.

The computing system of the present disclosure may be implemented as a communicable desktop computer, a laptop computer, a notebook, a smart phone, a tablet personal computer (PC), a mobile phone, a smart watch, a smart glass, an e-book reader, a portable multimedia player (PMP), a portable game console, a navigation device, a digital camera, a digital multimedia broadcasting (DMB) player, a digital audio recorder, a digital audio player, digital video recorder, digital video player, a personal digital assistant (PDA), etc.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The present invention was developed by the Korea Advanced Institute of Science and Technology (project executing organization) in the process of conducting a research project on DRAM PIM design-based technology development (Project Unique Number 1711193143, Project Number 2022-0-01172-002, Research Period 2023.01.01˜2023.12.31) among the PIM Artificial Intelligence Semiconductor Core Technology Development Project, which is a research project supported by the Ministry of Science and ICT and the Institute of Information & communications Technology Planning & Evaluation.

The present invention was developed by Pohang University of Science and Technology (project executing organization) in the process of conducting a research project on Development of Ultra-Thin Film Specific Conductivity Materials Using Crystalline-Amorphous Nanocomposite and Verification of Application Technology for Multi-Array Computing (Project Unique Number 1711198899, Project Number 2022M3H4A1A04096496, Research Period 2023.07.01˜2024.02.29) among the Nanomaterial Technology Development Project, which is a research project supported by the Ministry of Science and ICT and the National Research Foundation of Korea.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A computing system, comprising:
a processor; and
a neural network,
wherein the processor obtains a third block circulant matrix, which is the Hadamard product of a first block circulant matrix and a second block circulant matrix from each layer of the neural network,
trains the neural network by utilizing the third block circulant matrix as weights, and
fine-tunes the first block circulant matrix and the second block circulant matrix by pruning a plurality of first sub-block circulant matrices included in the learned first block circulant matrix and a plurality of second sub-block circulant matrices included in the learned second block circulant matrix, respectively, for an arbitrary layer among layers of the neural network.

2. The computing system of claim 1, wherein the processor, when pruning the first sub-block circulant matrices and the second sub-block circulant matrices, calculates the norm values of third sub-block circulant matrices generated by the Hadamard product of the first sub-block circulant matrices and the corresponding second sub-block circulant matrices, sorts the calculated norm values, and determines which matrices to prune from the first sub-block circulant matrices and the second sub-block circulant matrices based on a predetermined pruning ratio.

3. The computing system of claim 2, wherein the processor determines the sub-block circulant matrices to be pruned as those with the smallest norm values among the sorted norm values, starting from the smallest, up to a quantity equal to the product of the predetermined pruning ratio and the number of first sub-block circulant matrices.

4. The computing system of claim 1, wherein while the output accuracy of the neural network using the fine-tuned first block circulant matrix and the fine-tuned second block circulant matrix is equal to or greater than a predetermined accuracy, the process of fine-tuning by pruning the first block circulant matrix and the second block circulant matrix is repeated.

5. The computing system of claim 2, wherein the predetermined pruning ratio is updated by adding a predetermined step pruning ratio each time the first block circulant matrix and the second block circulant matrix are fine-tuned.

6. The computing system of claim 1, wherein the processor, upon completion of pruning, performs a Fast Fourier Transform on a pruned third block circulant matrix, which is the Hadamard product of a pruned first block circulant matrix and a pruned second block circulant matrix,
provides the transformed values as inputs to accelerators for the operations of each layer,
and provides index values regarding whether pruning has occurred to the accelerator to ensure that operations are not executed for the pruned sub-block circulant matrices among the sub-block circulant matrices of the pruned third block circulant matrix, the accelerators performing operations between the transformed values and the input data of the neural network only for the non-pruned sub-block circulant matrices excluding the pruned sub-block circulant matrices among the sub-block circulant matrices of the pruned third block circulant matrix using the index values.

7. A neural network training and compression method, comprising:
obtaining a third block circulant matrix, which is the Hadamard product of a first block circulant matrix and a second block circulant matrix from each layer of the neural network;
training the neural network by utilizing the third block circulant matrix as weights; and
fine-tuning the first block circulant matrix and the second block circulant matrix by pruning a plurality of first sub-block circulant matrices included in the learned first block circulant matrix and a plurality of second sub-block circulant matrices included in the learned second block circulant matrix, respectively, for an arbitrary layer among layers of the neural network.

8. The neural network training and compression method of claim 7, wherein the fine-tuning comprises:
calculating the norm values of third sub-block circulant matrices generated by the Hadamard product of the first sub-block circulant matrices and the corresponding second sub-block circulant matrices;
sorting the calculated norm values; and
determining the first sub-block circulant matrices and the second sub-block circulant matrices corresponding to a determined number of small norm values as matrices to be pruned using a predetermined pruning ratio.

9. The neural network training and compression method of claim 8, wherein the determining the first sub-block circulant matrices and the second sub-block circulant matrices as matrices to be pruned comprises determining the sub-block circulant matrices to be pruned as those with the smallest norm values among the sorted norm values, starting from the smallest, up to a quantity equal to the product of the predetermined pruning ratio and the number of first sub-block circulant matrices.

10. The neural network training and compression method of claim 7, wherein while the output accuracy of the neural network using the fine-tuned first block circulant matrix and the fine-tuned second block circulant matrix is equal to or greater than a predetermined accuracy, the process of fine-tuning by pruning the first block circulant matrix and the second block circulant matrix is repeated.

11. The neural network training and compression method of claim 8, wherein the fin-tuning further comprises updating the predetermined pruning ratio by adding a predetermined step pruning ratio each time the first block circulant matrix and the second block circulant matrix are fine-tuned.

12. A neural network computation accelerator, comprising:
a buffer configured to receive input data for each layer of a neural network, a pruned weight block circulant matrix, and index values indicating whether pruning has occurred;
a fast Fourier transform (FFT) processing element bank configured to perform a fast Fourier transform on the input data;
a Multiply-Accumulate (MAC) processing element bank configured to perform multiplication and accumulation operations between the fast Fourier transform data and a sub-block circulant matrix of the weight block circulant matrix;
a nonlinear module; and
a controller;
wherein the controller utilizes the index values regarding whether pruning has occurred to skip the execution of the MAC processing element bank for the pruned sub-block circulant matrices, executes the MAC processing element bank for the non-pruned sub-block circulant matrices, controls the FFT processing element bank to perform an inverse fast Fourier transform on the execution result data from the MAC processing element bank, and passes the transformed data through the nonlinear module to output as the output data of the layer.

13. The neural network computation accelerator of claim 12, further comprising a shift operator interposed between the FFT processing element bank and the nonlinear module and configured to divide the block size of the weight block circulant matrix.

14. The neural network computation accelerator of claim 12, wherein the pruned weight block circulant matrix is the fast Fourier transformed data.

15. The neural network computation accelerator of claim 12, wherein the pruned weight block circulant matrix is a third block circulant matrix obtained by performing the Hadamard product of a first block circulant matrix and a second block circulant matrix for each layer of the neural network, training the neural network using the third block circulant matrix as weights, and fine-tuning the first block circulant matrix and the second block circulant matrix by pruning a plurality of first sub-block circulant matrices included in the learned first block circulant matrix and a plurality of second sub-block circulant matrices included in the learned second block circulant matrix for an arbitrary layer among layers of the neural network, resulting in the third block circulant matrix obtained from the Hadamard product of the fine-tuned first block circulant matrix and the fine-tuned second block circulant matrix.
